(19) United States
(12) Patent Application Publication
(10) Pub. No.: US 2014/0230062 A1
(43) Pub. Date: Aug. 14, 2014

(54) DETECTING NETWORK INTRUSION AND ANOMALY INCIDENTS

(71) Applicant: Cisco Technology, Inc., San Jose, CA (US)

(72) Inventor: Vikram Kumaran, Cary, NC (US)

(73) Assignee: Cisco Technology, Inc., San Jose, CA (US)

(21) Appl. No.: 13/962,863

(22) Filed: Aug. 8, 2013

Related U.S. Application Data
(60) Provisional application No. 61/763,891, filed on Feb. 12, 2013.

(51) Int. Cl. G06F 21/56

(52) U.S. Cl. CPC G06F 21/56
USPC 726/24

(57) ABSTRACT

In an embodiment, a method comprises: using computing apparatus, receiving one or more data streams, determining one or more characteristics of the one or more data streams, and based on the one or more characteristics of the one or more data streams, determining one or more tags for the one or more data streams; determining whether the one or more tags indicate one or more malicious patterns representative of network intrusions; in response to determining that the one or more tags indicate one or more malicious patterns representative of network intrusions: generating, based on the one or more tags, one or more aggregated alert streams; applying one or more rules to the one or more aggregated alert streams and receiving a result indicating whether a network intrusion is in progress; in response thereto, determining and executing one or more remedial actions.

### BENEFIT CLAIM

This application claims the benefit under 35 U.S.C. §119(e) of provisional application 61/763,891, filed Feb. 12, 2013.

### FIELD OF THE DISCLOSURE

The present disclosure generally relates to computer networks. The disclosure relates more specifically to techniques for detecting instances of network intrusion and anomalies.

### BACKGROUND

The approaches described in this section are approaches that could be pursued, but are not necessarily approaches that have been previously conceived or pursued. Therefore, unless otherwise indicated, it should not be assumed that any of the approaches described in this section qualify as prior art merely by virtue of their inclusion in this section.

Performing intrusion detection in computer networks in real-time is usually complex and challenging. Most commercial systems configured to detect instances of network intrusion execute algorithms for parsing network traffic data and matching the parsed information with known signatures of network intrusion. Since only known signatures are considered, the systems can only detect reoccurrences of the known network viruses and attacks. Furthermore, since new methods of intrusion and improvements to the methods are developed daily, the libraries of known signatures are rarely complete, and thus the systems very quickly become obsolete.

Some commercial systems implement algorithms for detecting instances of anomalies occurring in the network traffic. Detection of anomalies is different than detection of known virus signatures because its basis is new signatures and patterns that were not observed in the past. However, identifying the new signatures and patterns is often prone to errors, and some of the newly defined signatures and patterns may be false positives.

Some other systems for determining malicious attacks are configured as self-learning adaptive systems. To determine whether a network is under attack, adaptive systems usually execute lengthy sequences of iterations and pattern matching. The systems usually adopt a traditional “store-first-and query-later” approach, and often utilize quarantine buffers. Therefore, such systems are rarely capable of performing their tasks in real-time. Furthermore, such systems are rarely adaptable to networks that support voluminous and fast traveling traffic.

### BRIEF DESCRIPTION OF THE DRAWINGS

In the drawings:

FIG. 1 illustrates an embodiment of a system configured to detect incidents of network intrusion and anomaly;

FIG. 2 illustrates an embodiment of a system configured to detect incidents of network intrusion and anomaly;

FIG. 3 illustrates an embodiment of a process for detecting incidents of network intrusions and anomaly;

FIG. 4 illustrates an embodiment of a process for dividing a raw stream of data into data streams;

FIG. 5 illustrates an embodiment of a process for labeling events and data streams;

FIG. 6 illustrates an embodiment of a process for detecting incidents of network intrusions and anomaly;

FIG. 7 illustrates an embodiment of a process for applying rules to alert streams;

FIG. 8 illustrates an example computer system with which an embodiment may be implemented.

### DESCRIPTION OF EXAMPLE EMBODIMENTS

In the following description, for the purposes of explanation, numerous specific details are set forth in order to provide a thorough understanding of the present disclosure. It will be apparent, however, to one skilled in the art that the present disclosure may be practiced without these specific details. In other instances, well-known structures and devices are shown in block diagram form in order to avoid unnecessarily obscuring the present disclosure.

Embodiments are described herein according to the following outline:
1.0 Overview
2.0 Structural and Functional Overview
3.0 Detecting Incidents of Network Intrusion and Anomaly
   3.1 Dividing Incoming Event Stream into Data Streams
   3.2 Example Data Splitter
   3.3 Event Labeling
   3.4 Example Event Labeler
   3.5 Detectors
      3.5.1 Intra-Event Misuse Detection
      3.5.2 Anomaly Detection
      3.5.3 Discrete Event Sequence Intrusion Detection
      3.5.4 Clustering Based Anomaly Detection
   3.6 Rules
4.0 Implementation Mechanisms—Hardware Overview
5.0 Extensions and Alternatives

1.0 Overview

In an embodiment, a computer-implemented data processing method comprises using computing apparatus to receive one or more data streams, and send the data streams to a streaming database. One or more characteristics of the one or more data streams are determined. Based on the one or more characteristics of the one or more data streams, one or more tags for the one or more data streams are determined. A determination is made whether the one or more tags indicate one or more malicious patterns representative of an instance of network intrusion. In response to determining that the tags indicate malicious patterns representative of network intrusions, one or more aggregated alert streams are generated based on the tags. One or more rules are applied to the one or more aggregated alert streams to determine whether an indication that a network intrusion is in progress is received. In response to receiving an indication that the network intrusion is in progress, one or more remedial actions are determined and executed.

2.0 Structural and Functional Overview

In an embodiment, a computer-implemented process, computer system and computer program are provided for detecting instances of network intrusion and anomaly. The system described herein may be implemented in any type of computer platform. For example, the system may be implemented in the event stream database architecture. The system may also be implemented in a router, switch or any other network device.

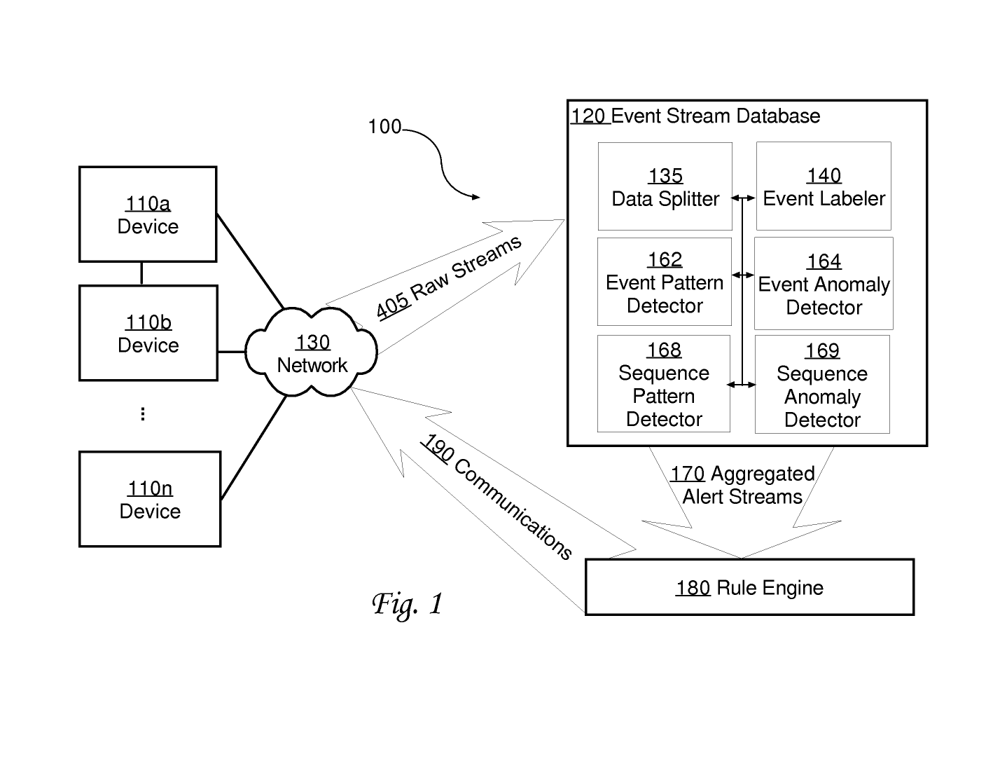

FIG. 1 illustrates an embodiment of a system 100 configured to detect incidents of network intrusion and anomaly. In an embodiment, computer system 100 comprises one or more devices 110a, 110b, 110n, one or more networks 130, and one or more event stream databases 120. For the purpose of illustrating clear examples, FIG. 1 shows three devices 110a, 110b, 110n; however, other embodiments may use any number of devices as suggested by the ellipsis between devices 110b, 110n.

In an embodiment, devices 110a, 110b, 110n represent various devices configured to received, process and transmit data. The devices include any type of computing devices such as computer workstations, laptops, PDA devices, smartphones, tablet devices or any other computer devices configured to receive, process, and transmit data. The devices may also include routers, switches, firewalls, data storing servers, email servers, and other devices configured to send, process, and transmit data. For example, a device 110a may be a user station used by a user to create and transmit email communications, a device 110b may be an email server transmitting email communications between devices 110a and 110n, and a device 110n may be a tablet device configured to facilitate email communications with device 110a.

Network 130 facilitates communications between devices 110a, 110b, 110n, and a stream database 120. For example, network 130 may be configured to receive information from devices 110a, 110b, 110n, use the received information to form one or more raw streams of data 405, and transmit the one or more raw streams 405 to an event stream database 120. Further, network 130 may be configured to receive one or more communications 190 from a rule engine 180, and transmit the communications 190 to their respective recipients, including devices 110a, 110b, 110n.

In an embodiment, one or more raw streams 405 comprise network traffic flows and network event flows. Network traffic flows may include data sent between software applications executed on user workstations, servers, routers, switches and other devices. Network event flows may include data comprising messages, notifications, error messages, confirmation and other event-describing communications generated by syslog applications, system trap applications, and the like.

Event stream database 120 may be any type of process, system or device configured to receive, store, process, and transmit data. Examples of such devices include flat files, distributed storage, relational databases, or any other data repository. Data entered into event stream database 120 may be managed by an information system hosted or executing using another computer. Data entered into event stream database 120 may be entered as one or more raw streams 405. For example, one or more raw streams 405, such as streams of emails, may be transmitted from network 130 to an event stream database 120.

Event stream database 120 may be configured to request, intercept, receive, process, and analyze one or more raw streams 405. Event stream database 120 may receive raw streams 405 directly or indirectly from devices 110a, 110b, 110n, or directly or indirectly from network 130. Event stream database 120 may also receive raw streams 405 from other sources (not depicted in FIG. 1).

In an embodiment, a stream database 120 comprises one or more data splitters 135, one or more event labelers 140, one or more event pattern detectors 162, one or more event anomaly detectors 164, one or more sequence pattern detectors 168, and one or more sequence anomaly detectors 169. Data splitters 135 may be configured to divide raw streams 405 into one or more streams of data. Event labelers 140 may be configured to assign labels to events in the streams of data and to the streams of data. Detectors 162-169 may be configured to analyze the labeled events and the labeled streams of data to detect incidences of network intrusion and anomaly.

In an embodiment, event stream database 120 generates one or more aggregated alert streams 170. The aggregated alert streams 170 may comprise streams of various alerts and notifications generated during processing of the raw streams 405.

One or more aggregated alert streams 170 may be transmitted to a rule engine 180. A rule engine 180 may be configured to store one or more rules and use the rule to determine whether individual alerts and a combination of alerts in the aggregated alert streams 170 indeed indicate an intrusion attack or a malicious activity. The rules may include if-then rules and other types of rules. The rules may be defined by a system administrator, a network manager, or a user. The rules may be part of commercially distributed rule-applications, developed by third-parties.

A rule engine 180 may generate and transmit various types of communications 190 to network 130. For example, a rule engine 180 may generate error notifications, commands, electronic mails, instant messages, and other communications to indicate errors, problems and issues. The communications 190 may also include virus signatures, virus patterns, and other information specific to instance of network intrusion. The communications 190 may be sent to network managers, system administrators and users.

In response to receiving one or more communications 190, network managers, administrator or users may determine a course of action. For example, upon receiving a virus signature, a network administrator may add the virus signature to a virus library and include the virus signature in virus scanners and applications. Upon receiving an indication that a particular device is sending spam messages, an IP address of the particular device may be added to a black list of hosts considered as suspected of malicious attacks.

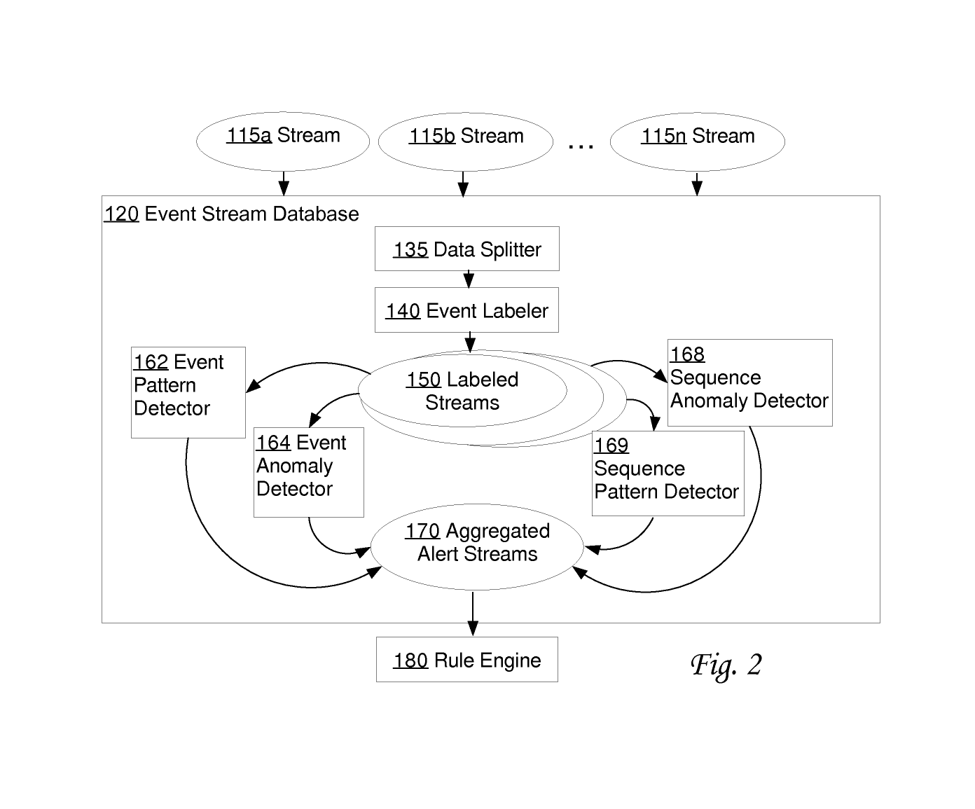

FIG. 2 illustrates an embodiment of a system configured to detect incidents of network intrusion and anomaly. In an embodiment, the system comprises an event stream database 120 that receives one or more input streams 115a, 115b, 115n, processes the input streams, generates one or more aggregated alert streams 170, and transmits the aggregated alert streams 170 to a rule engine 180.

Configurations of an event stream database 120 may vary between implementations, and the types and quantity of components implemented within the stream database 120 may depend on the type of the service facility.

In an embodiment, each of the functional units previously described for FIG. 1 and each of the processes described in connection with the functional blocks of FIG. 2 may be implemented using one or more computer programs, other software elements, or digital logic in any of a general-purpose computer or a special-purpose computer, while performing data retrieval, transformation and storage operations that involve interacting with and transforming the physical state of memory of the computer. Or, event stream database 120 or related computing devices may implement the processes described herein using hardware logic such as in an application-specific integrated circuit (ASIC), field-programmable gate array (FPGA), system-on-a-chip (SoC) or other combinations of hardware, firmware and/or software.

In an embodiment, an event stream database 120 may comprise one or more processors (not depicted in FIG. 2). The processors may be configured to execute commands and instructions specific to stream database 120. For example, a processor may facilitate communications to and from stream database 120, process commands received and executed by stream database 120, process responses received by stream database 120, and facilitate various types of operations executed by stream database 120. A processor may comprise hardware and software logic configured to execute various processes on stream database 120.

In an embodiment, an event stream database 120 comprises one or more data splitters 135, one or more event labelers 140, one or more event pattern detectors 162, one or more event anomaly detectors 164, one or more sequence pattern detectors 168, and one or more sequence anomaly detectors 169. In other embodiments, the functions of more than one of the units 135-169 may be combined. For example, as depicted in FIG. 2, stream database 120 may comprise one data splitter 135, one event labeler 140, one event pattern detector 162, one event anomaly detector 164, one sequence pattern detector 168 and one sequence anomaly detector 169. In other embodiments, the functionalities of units 135-169 may be combined and the quantity of various types of the units may be reduced.

Data splitter 135 may be configured to divide, or split, one or more raw streams 115a, 115b, 115n into one or more distinct data streams. Data splitter 135 may split the raw streams 115a, 115b, 115n based on specific characteristics of the raw streams 115a, 115b, 115n. The specific characteristics may include various physical characteristics, characteristics of communications attributes, characteristics specific to network bandwidth and throughput, and data packet-specific characteristics. Characteristics of physical attributes and communications attributes of the stream may be identified from the headers of communications included in the stream. Network and data flow characteristics may include bandwidth characteristics of the data stream, throughput information, counts of connections used to transmit the stream data, and the like.

In an embodiment, characteristics of raw streams 115a, 115b, 115n include the characteristics obtained by a deep packet inspection of the packet content. For example, a deep packet inspection of the packet may be performed to identify various types of information, including keywords uttered in the message headers, keywords uttered in the message body, and the like. The keywords may be used as values of specific characteristics of the input streams.

In an embodiment, one or more distinct data streams identified by a data splitter 135 are transmitted to an event labeler 140 for further processing.

Event labeler 140 may be configured to receive one or more distinct data streams from a data splitter 135, analyze characteristics of the distinct data streams, and determine one or more tags for the streams.

In an embodiment, event labeler 140 may determine one or more tags for a data stream. Determining a tag may comprise analyzing the data stream and the characteristics associated with the data stream, and testing whether the characteristics satisfy one or more conditions. If the characteristics of the data stream satisfy a particular condition, then a tag associated with the particular condition may be associated with the data stream.

Conditions used by event labeler 140 may be defined in advance of a time of processing event data. The conditions may be applied to values of characteristics identified for a data stream. For example, if a particular data stream comprises emails and one of the characteristics of the emails include a count of the emails sent from a particular host within a certain period of time, then the event labeler 140 may determine whether there is a condition that may be applied to the characteristics. If so, event labeler 140 may apply the condition and determine a tag for the event or the stream. A particular condition may indicate that if more than a certain threshold count of emails was sent from a particular host within a certain period of time, then a tag, indicating “potential spam” may be associated with the data stream.

An event labeling may be performed using a variety of approaches, including threshold-based triggers, stochastic triggers, pattern triggers, and the like. A threshold-based-trigger uses a threshold value or a threshold range to determine whether a tag associated with the trigger may be assigned to the event. For example, a threshold value or a threshold range may be compared with a value of an attribute or characteristic of the event, and, based on the outcome a corresponding tag may be assigned to the event.

A stochastic trigger may be used to determine whether event characteristics satisfy a condition comprising some statistical information. The stochastic triggers are used to identify statistical anomalies in a data stream. For example, a statistical anomaly may be present when communicating the data stream imposes bandwidth requirements above a historic mean value for the bandwidth for transmitting data.

A pattern trigger may use a variety of conditions and apply the conditions to characteristics of a data stream to determine whether there is a certain pattern in the characteristics of the data stream.

Once the data streams are labeled with one or more labels, the labeled data streams are transmitted to detectors 162-169. Detectors 162-169 may be configured to perform various tests and checks on the labeled data streams. The detectors may perform algorithms for identifying instances of malicious behaviors and anomalies associated with transmitted data streams.

Unlike an event labeler 140, which is configured to analyze individual events, detectors 162-169 are configured to analyze various combinations and sequences of events and streams of events. Detectors 162-169 consider one or more data streams as a whole, and analyze all the tags assigned to the data streams taken as a whole. For example, detectors 162-169 may be configured to identify patterns within individual events as well as in various sequences of events.

In an embodiment, detectors 162-169 execute different detection mechanisms in parallel and on multiple data streams. Each of the detectors may be configured to identify instances of malicious behavior or instances of anomalies.

In an embodiment, detectors 162-169 comprise one or more event pattern detectors 162, one or more event anomaly detectors 164, one or more sequence anomaly detectors 168 and one or more sequence pattern detectors 169. Although FIG. 2 depicts one of each detector 162-169, other implementations may comprise additional components or may comprise fewer components than depicted in FIG. 2. For example, in other embodiments, the functionalities of detectors 162-169 may be combined and the quantity of various types of the detectors may be reduced. Although not depicted in FIG. 2, additional types of detectors may also be included in a stream database 120.

In an embodiment, an event pattern detector 162 is configured to analyze tags associated with events in distinct data streams and, based on the tags, determine whether any pattern indicative of an instance of network intrusion may be identified.

In an embodiment, an event anomaly detector 164 is configured to analyze tags associated with events in distinct data streams and, based on the tags, determine whether any pattern indicative of an instance of network anomaly may be identified.

In an embodiment, a sequence anomaly detector 168 is configured to analyze sequences of tagged events in distinct data streams and, based on the tags determine whether any pattern indicative of an instance of network anomaly may be identified.

In an embodiment, a sequence pattern detector 169 is configured to analyze sequences of tagged events in distinct data streams and, based on the tags determine whether any pattern indicative of an instance of network intrusion may be identified.

In an embodiment, one or more of detectors 162-169 may generate an alert stream comprising various types of communications related to alerts. Examples of alerts may include notifications, error messages, commands, instant messages and other forms of communications that may be used to indicate that a network is under attack.

In an embodiment, one or more streams of alerts may be aggregated into one or more aggregated alert streams 170. The process of aggregating alert streams may include grouping the alert streams based on identifiers of the hosts that generated the data streams, identifiers of the hosts that are intended recipients of the data streams, types of packets included in the data streams, and the like. One or more aggregated alert streams 170 may be transmitted to a rule engine 180.

Rule engine 180 may be configured to store one or more rules and use the rules to determine whether information included in aggregated alert streams 170 indeed indicates an intrusion attack or any other type of malicious activity. The rules may include if-then rules and other types of rules. The rules may be defined by system administrators, network managers and users. The rules may be also provided as part of commercially distributed rule-applications, developed by third-parties.

Rule engine 180 may apply one or more rules to aggregated alert streams 170. An application of a rule to aggregated alert streams 170 may include testing whether one or more conditions defined by the rule apply to the information included in the alert streams 170. If the conditions are met, then one or more actions associated with the rule may be identified. The actions may include sending one or more communications to a system administrator, generating and sending out one or more commands, generating and sending one or more error messages, and the like. The actions that are meant to remedy problems indicated by data included in the aggregated alert streams are referred to as remedial actions.

3.0 Detecting Incidents of Network Intrusion and Anomaly

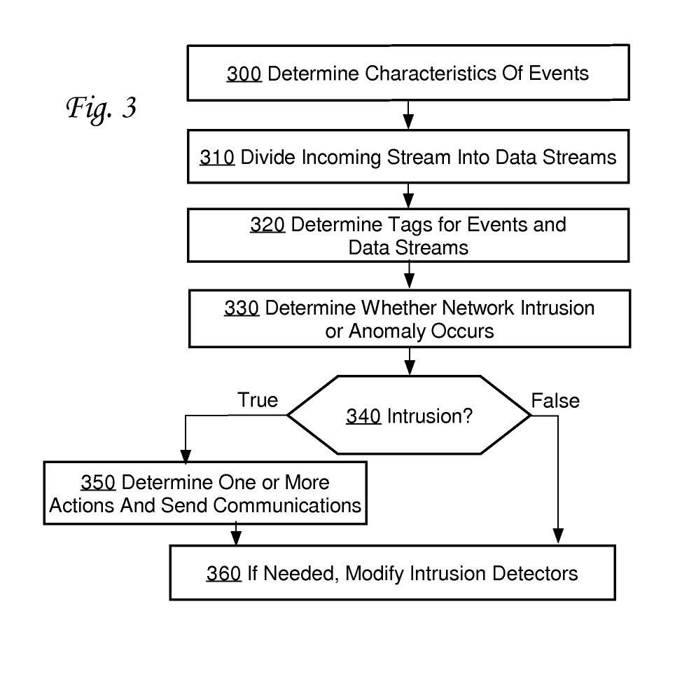

FIG. 3 illustrates an embodiment of a process for detecting incidents of network intrusion and anomaly. In step 300, a raw stream of data is received at an event stream database and one or more characteristics of the events included in the raw stream of data are determined.

In an embodiment, a raw stream of data comprises event data and traffic flow data. Event data includes data indicating events occurring in a network. Traffic flow data includes sequences of data packets exchanged between network devices using communications connections and sessions.

A raw stream of data received by an event stream database usually includes a high volume of the data transmitted at a high speed. For example, the stream of events may include a large volume of data comprising communications events, messages, notifications, commands and other communications, generated by various applications, including the netflow, syslog, system traps, and other applications configured to disseminate data.

Given the large volume of the incoming stream, its high speed, and the fact that new data is constantly streamed to an event stream database, the database has usually very little time to analyze the received stream and determine whether the data indicates incidents of intrusion on a network. Thus, the processes of analyzing the data and determining whether the network is under attack are optimized to minimize the latency time as much as possible.

In an embodiment, a process of detecting instances of network intrusion and anomaly includes determining characteristics of incoming streams of data. Determining one or more characteristics of an incoming stream may be performed using a variety of approaches. For example, the events in the incoming stream may be analyzed to determine whether one or more tags may be associated with the events. For example, if a stream of events comprises syslog messages indicating that a particular host experiences instances of a buffer overflow, then the events indicating the instances of the buffer overflow may be characterized as “buffer-flow” events. If a stream of events comprises syslog messages indicating that a particular host experiences instances of heavy traffic, then the events indicating the instances of the heavy traffic may be characterized as “heavy-traffic” events.

In an embodiment, characteristics of events include physical attributes associated with the events. The physical attributes may be identified from the headers of communications including the events. For example, in a data stream comprising data packets or data segments, a header of the packet (or a segment) may include one or more attributes that may be used as characteristics of the event.

In an embodiment, physical attributes may include a physical location of a sender of the data stream, a physical location of a recipient of a data stream, a device type of a sender or a recipient, a MAC address of the device of a sender or a recipient, an IP address of a sender or a recipient, and any other types of information included in the communications of the data stream.

In an embodiment, characteristics of events include communications attributes associated with the events. The communications attributes may be identified from headers of the communications including the events. Examples of communications attributes include identifiers of communication protocols used to transmit the communications included in the data stream. For example, communication attributes may include NBAR, NBAR2 (network protocols facilitating stateful analysis of transmitted data packets), QoS protocol, IP protocol, TCP/IP protocol, and the like.

In an embodiment, characteristics of traffic flows include network and data flow characteristics of the data streams. Network and data flow characteristics may include bandwidth characteristics of the data stream, throughput of the network connections, counts of connections used to transmit the data stream, and the like.

In an embodiment, characteristics of data flows include the characteristics obtained by a deep-packet-inspection of contents of the data flow packets. Upon performing a deep-packet-inspection of the packet, various types of information may be derived from the content of the packet. The information may comprise keywords included in the message headers, keywords identified in the message body, and the like. The keywords may be used as values of specific characteristics of the data stream.

3.1 Dividing Incoming Raw Stream into Data Streams

Referring again to FIG. 3, in step 310, an incoming data stream is divided into one or more data streams. Dividing an incoming stream into data streams may be performed using a variety of approaches. For example, once event characteristics have been identified for the incoming stream, the stream may be divided into one or more data streams based on the identified characteristics. Hence, if two characteristics have been identified for events included in the incoming stream such as a “buffer-overflow” and a “heavy-traffic,” then the two characteristics may be used to divide the incoming stream into two data streams: an event stream containing “buffer-overflow” events, and an event stream containing “heavy traffic” events.

A process of dividing an incoming data stream into one or more data streams allows processing the incoming data stream efficiently and in a relatively short period of time. Processing of the incoming data stream efficiently and quickly allows an expedited identification of incidents of network intrusion in time-sensitive applications.

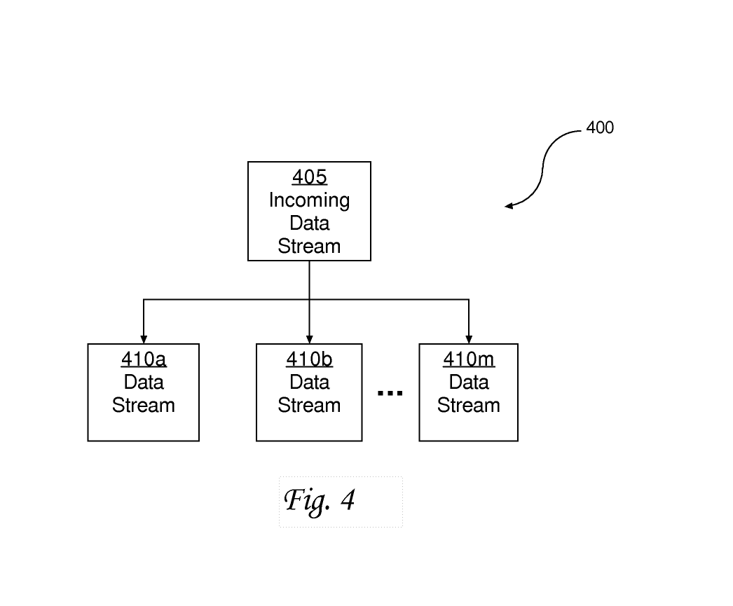

FIG. 4 illustrates an embodiment of a process 400 for dividing an incoming data stream into one or more data streams. In an embodiment, an incoming data stream 405 is divided into one or more data streams 410a, 410b, 410m. For the purpose of illustrating clear examples, FIG. 4 shows three data streams 410a, 410b, 410m; however, other embodiments may divide the incoming data stream into more than three data streams, as suggested by the ellipsis between devices 410b, 410m. Other embodiments may divide the raw stream into two data streams. In some cases, the incoming data stream may not be divided any further.

In an embodiment, dividing an incoming data stream into one or more data streams is performed using Prime Analytics products, commercially available from Cisco Systems, Inc., San Jose, Calif., and including a superset implementation of Structured Query Language (SQL) query language denoted TruSQL.

TruSQL provides mechanisms for defining queries and executing the queries on an incoming data stream. TruSQL defines a stream as an ordered unbounded relation of a plurality of events. The events in a stream may be ordered based on a time attribute. Furthermore, TruSQL uses the idea of a time window. A time window is used to provide a bounded sequence of relations over which the TruSQL query is applied. A time window is also referred to as a visible window.

Below is an example of a TruSQL query that uses a “visible window” approach. The example TruSQL query is referred to as a “continuous” query:

Query 1: Example TruSQL Continuous Query

SELECT url, count(*)url_count
FROM url_stream < VISIBLE ‘5 minutes’
ADVANCE ‘1 minute’>
WHERE url LIKE ‘%Order.do%’
GROUP BY url
ORDER BY url_count desc
LIMIT 20

In Query 1 the keyword VISIBLE defines a visible window, which is applied to the incoming data stream and allows selecting a portion of the incoming stream. In the example of Query 1, the keyword VISIBLE specifies the window of five minutes for selecting a portion of the stream bounded to a five minutes time period. The keyword ADVANCE specifies an increment step and allows moving the visible window from one time interval to another. Further, the keyword ADVANCE specifies a one-minute-long time increment, allowing moving the visible window by one minute every minute as new data is received.

The example Query 1 provides one of many windowing mechanisms. Other approaches for defining and moving a visible window include tumbling windows approaches and landmark widows approaches. These approaches facilitate different types of aggregations and stream filtering than the visible window approach described above.

TruSQL also defines mechanisms for writing multiple queries that may be executed on multiple data streams. Examples of TruSQL queries that may be executed on a data stream to divide the stream into one or more data streams are described below. Such queries may be processed in parallel.

One of the advantages of dividing an incoming data stream into one or more derived streams is the fact that the processing may be performed in memory as the data tuples are received at an event stream database. Processing the tuples in the memory is usually very efficient. It is also a low latency solution for real-time analysis of the incoming data streams.

3.2 Example Data Splitter

In an embodiment, a process of dividing an incoming stream of data is performed by a data splitter. A data splitter may be configured to divide a raw stream of data into one or more data streams. The raw stream of data may be divided based on one or more characteristics of the events and traffic data included in the stream. The characteristics may include physical characteristics, communication-related characteristics, flow-specific characteristics, and packet-content-related characteristic.

In an embodiment, dividing a raw stream of data is performed using the TruSQL approach. In this approach, a TruSQL query is defined to produce one or more derived streams from the raw stream of events.

In an embodiment, a TruSQL query for dividing a raw stream of data into one or more derived streams is a continuous query. The TruSQL may comprise a WHERE clause to produce the derived stream, specifying a filter that allows selecting items from the input data. The WHERE clause may be used to determine whether a particular characteristic of the event included in the raw stream has a particular value. For example, the WHERE clause may be used to determine whether a host identifier included in a header of the event communication is the same as a particular host identifier.

In TruSQL, continuous queries may be executed in parallel on the same raw stream of data. For example, each of the continuous queries may use a different WHERE clause. The WHERE clause may be used to apply filter criteria and split data streams, while the inner and outer joins may be used to combine multiple data streams into one stream based on the join condition.

Below is an example of two continuous queries that split a single netflow raw stream into two derived streams. The first query identifies the flow events that are related to traffic from and to a specific host in a network. The second query identifiers the flow events that are related to secure shell (SSH) tunnel traffic.

Query 2: Example TruSQL Query Comprising a Specific Host Filter.

CREATE STREAM 20_1_1_70_traffic_stream
( event_time cqtime,
source_ip4,
dest_ip4,
counter_bytes
) AS
SELECT event_time, source_ip4,
dest_ip4, src_port,
dest_port, counter_bytes
FROM netflow_stream
WHERE source_ip4 = 20.1.1.70
OR dest_ip4 = 20.1.1.70;

Query 3: Example TruSQL Query Comprising
a Communication Protocol Filter.

```
CREATE STREAM ssh_traffic_stream
(source_ip4,
dest_ip4,
traffic_bytes,
event_time cqtime,
) AS
SELECT source_ip4, dest_ip4,
    src_port, dest_port,
sum(counter_bytes) traffic_bytes,
cq_close(*) as window_close_time
FROM netflow_stream <slices ‘1 minute’>
WHERE
    Nbar_app = ‘ssh’
GROUP BY
    source_ip4, dest_ip4,
    dest_port, src_port;
```

Query 2, Query 3 are examples of queries that when executed create two independent parallel derived streams. The derived streams may be ported to other processing units for further processing.

3.3 Event Labeling

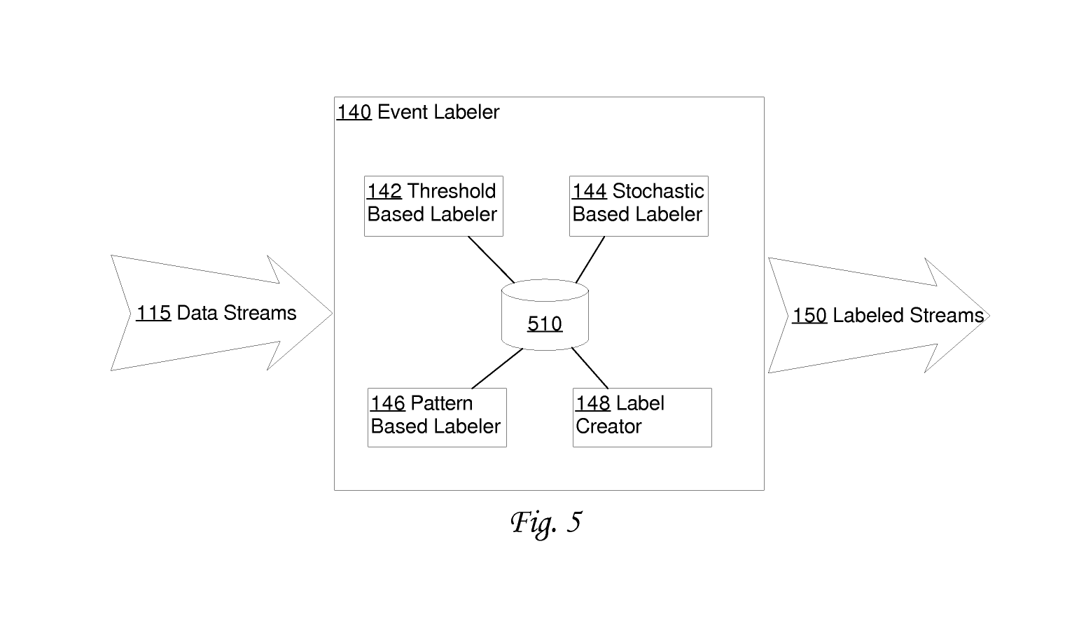

Referring again to FIG. 3, in step 320, one or more tags are determined for one or more data streams and events included in the data streams. Event labeling may be performed by one or more event labelers. Event labelers may use a variety of approaches, including threshold-based triggers, stochastic triggers, pattern triggers, and the like. Examples of various labelers are depicted in FIG. 5.

FIG. 5 illustrates an embodiment of a process for labeling events and data streams. In an embodiment, an event labeler 140 receives one or more data streams 115, processes the received streams and generates one or more labeled streams 150.

In an embodiment, an event labeler 140 is configured to assign one or more labels based on one or more attributes of the events or streams of events. For example, event labeler 140 may use multiple attributes to determine one label for an event or a stream of events. According to another example, event labeler 140 may use one attribute of an event or stream of events to determine multiple labels for the event or the stream. Furthermore, event labeler 140 may use multiple attributes to determine multiple labels for one event or one stream of events.

Event labeler 140 may comprise one or more threshold-based labelers 142, one or more stochastic based labelers 144, and one or more pattern based labelers 146. Event labeler 140 may also comprise a data storage device 510 and a label creator unit 148. Label creator unit 148 may be configured to define and create one or more labels and to store the labels in a data storage device 510. The labels may be created in advance or using user-defined functions, as described below.

In an embodiment, a threshold based labeler 142 is configured to determine tags for events and data streams 115 using threshold triggers. A threshold-based-trigger may use a threshold value or a threshold range, compare the threshold value (range) with attribute values or characteristics of events or data streams, and determine whether the value satisfies the threshold-based condition. For instance, a particular threshold-based-trigger may use a particular threshold value to determine whether a value of a particular attribute of an event matches a particular threshold value. If a tested attribute is an IP address of a host that sent a particular data stream to a stream database, then the IP address of the host may be checked against a set blacklisted IP addresses, and if a match is found, then the event labeler 142 may associate a tag to the data stream to indicate a violation of data access or data security.

According to another example, a particular threshold-based-trigger may use a particular threshold value to determine whether a value of a particular attribute exceeds the threshold value, and if so, assign a particular tag to the data stream to indicate that the data stream comprises a threshold-exceeding event. For instance, a particular threshold trigger may use a particular threshold value to determine whether a count of communications indicating a buffer overflow experienced by a particular host exceeds the particular threshold value, and if so, associate a “buffer-overflow” tag to such communications.

According to another example, a particular threshold-based-trigger may use a particular threshold range to determine whether a value of a particular attribute remains within the particular threshold range, and if it does not, then assign a particular tag to the data stream to indicate that the data stream comprises an event having an attribute that is outside the particular threshold range. For instance, a particular threshold trigger may use a particular threshold range to determine whether an IP address of the host that sent traffic to the network is within the particular IP-address range, and, if it is not, then a “traffic-violation” tag is associated with such traffic.

In an embodiment, a stochastic based labeler 144 is configured to determine tags for events and data streams 115 using stochastic triggers. Stochastic triggers are used to identify statistical anomalies in a data stream. For example, a statistical anomaly may be present when communicating the data stream imposes bandwidth requirements above a historic mean value. In one approach, a tag indicating a statistical anomaly may be assigned to a data stream to indicate the bandwidth that is more than two standard deviations above a historic mean value.

In an embodiment, a pattern based labeler 146 is configured to determine tags for events and data streams 115 using patterns in attributes in characteristics of the events. Pattern-attribute approach focuses on determining whether there is a certain pattern in the characteristics of the events and data stream. For example, a particular pattern trigger may be associated with a condition for testing a particular attribute or a combination of attributes associated with the data stream. Examples of such combinations of attributes may include certain text snippets that may indicate a worm in the network packet content, or certain text fragments indicating a prohibited connection between two hosts using a disallowed communication protocol to communicate data.

3.4 Example Event Labeler

In an embodiment, a process of determining one or more tags for one or more data streams and events is performed by an event labeler. An event labeler may be configured to receive one or more distinct streams from a data splitter, analyze characteristics of the distinct streams and events included in the streams, and determine one or more tags for the events and streams.

In an embodiment, determining tags for events and data streams is performed using the TruSQL approach extended to incorporate the capabilities of the Prime Analytics system. The Prime Analytics system is an extension to the Postgres, and supports standard Postgres user-defined functions (UDF). The UDF allow coding the algorithms useful in event labeling.

In an embodiment, an example query designed to label data streams with tags based on a threshold trigger may be implemented as follows:

Query 4: Example TruSQL Query for
Event Labeling Based on a Threshold Value.

```
SELECT source_ip4,
        dest_ip4,
        traffic_bytes,
        event_time,
(CASE WHEN
        traffic_bytes > 2000,000 THEN ‘HIGH’
ELSE ‘LOW’
END) as traffic_label
FROM
ssh_traffic_stream;
```

In Query 4, a condition is checked whether a count of “traffic-bytes” identified for a particular data stream exceeds a value of 2,000,000. If the count of traffic bytes exceeds 2,000,000, then the label “HIGH” is assigned to the data stream to indicate a heavy volume of traffic. Otherwise, the label “LOW” is assigned to the data stream.

In an embodiment, an example query designed to label data streams with tags based on a stochastic attribute may be implemented as follows:

Query 5: Example TruSQL Query for
Event Labeling Based on Stochastic Attributes.

```
SELECT sts.source_ip4,
        sts.dest_ip4,
  Sts.avg_bytes,
        sts.event_time,
(CASE
    WHEN
        (hst.avg_traffic-sts_avg_bytes) > hst.std_dev*2
        THEN ‘ABNORMAL’
ELSE ‘NORMAL’
END) as traffic_label
FROM
  (SELECT source_ip4, dest_ip4,
AVG(traffic_bytes) as avg_bytes,
cq_close(*) as event_time,
    FROM
ssh_traffic_stream
          <slices’10 minutes’>) as sts,
          historic_ssh_traffic as hst
GROUP BY source_ip4, dest_ip4
```

In Query 5, a condition is checked whether a value of the bandwidth characteristic of a data stream is more than two standard deviations above the historic mean value. If the condition is satisfied, then the label “ABNORMAL” is assigned to the data stream to indicate the abnormal traffic. Otherwise, the label “NORMAL” is assigned to the stream.

In an embodiment, an example of a query designed to label data streams with tags based on a pattern trigger may be implemented as follows:

Query 6: Example TruSQL Query for
Event Labeling Based on Pattern in Attributes.

SELECT source_ip, msg,
(CASE WHEN
msg ~ E’Authorization failed .?\(.*f\df\d’
THEN ‘ACCESS_ALERT_386’
ELSE ‘NORMAL’
END) as alert_label
FROM syslog_stream;

In Query 6, a condition is checked whether a keyword characteristic of a syslog data stream indicating a failed authorization has been repeated according to a particular pattern. If so, then the label “ACCESS_ALERT_{—}386” is assigned to the data stream to indicate a possible attempt of security violation. Otherwise, the label “NORMAL” is assigned to the stream.

In an embodiment, an event labeler 140 may be configured to execute queries comprising user-defined functions for assigning tags to events and streams of events. The user-defined functions may allow determining tags using the approaches described above, including a threshold based approach, a stochastic based approach and pattern based approach.

User-defined functions may be configured to determine mappings from the patterns, thresholds and rules to labels. A mapping may be managed through event-mapping tables that define how the patterns, thresholds and stochastic rules correspond to the labels. The mapping may be described using metadata and the mapping metadata may be stored in a metadata table. The mapping may be represented using user-defined functions to dynamically assign labels to events and stream in real-time.

In an embodiment, assigning tags to event streams based on stochastic triggers includes using static tables. A static table may be defined with pre-calculated baseline statistics on historic data used for comparisons with event characteristics.

In an embodiment, assigning tags to event streams based on pattern triggers includes defining queries that rely on Postgres supports. Such queries may include regular expressions that can be used to match text patterns in characteristics attributes to predefined patterns. In an embodiment, an event labeler 140 utilizes labels generated manually or defined using user-defined functions. User-defined functions are custom computer programs installed within a stream database. They are called “user-defined” because they contain custom code written by a user, and they are not the statistical or pre-existing functions typically deployed with the platform.

An example of a query utilizing a user-defined function for assigning a tag to an event stream is provided below:

Query 7: Example TruSQL Query for
Event Labeling Using a User-Defined Function.

```
CREATE STREAM ssh_labeled_traffic_stream
(source_ip4 as text,
dest_ip4 as text,
traffic_bytes as integer,
event_time as timestamp cqtime ,
event_labels as text[ ]
) AS
SELECT source_ip4, dest_ip4,
    traffic_bytes, event_time,
    Event_labler_udf(source_ip4, dest_ip4, traffic_bytes) as
    event_labels
FROM ssh_traffic_stream;
```

In Query 7, values of various event attributes are encapsulated. The event attributes comprise a source IP address, a destination IP address, a traffic volume value and timestamp information. In response, a list of labels may be received for the events that have the specified event attributes.

The queries 4-7, described above, are provided to illustrate clear examples of determining and assigning tags to evens and streams of events. Other queries utilizing TruSQL may be developed and deployed in an event labeler 140.

3.5 Detectors

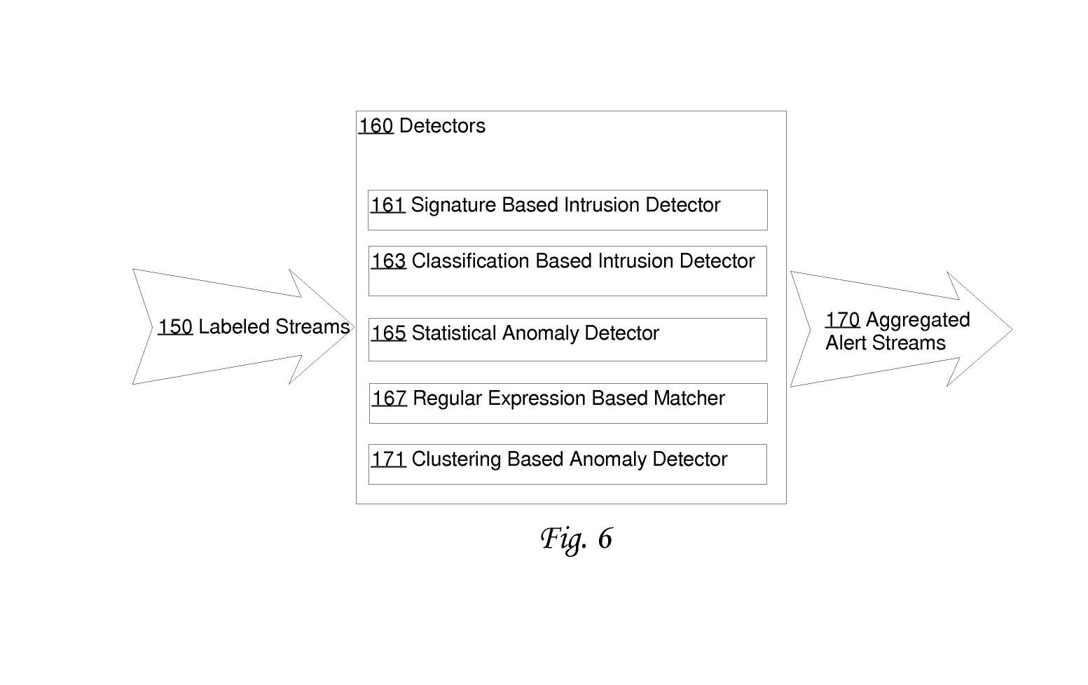

Referring again to FIG. 3, in step 330, a determination is made whether network intrusion or anomaly occurs. Determination of instances of network intrusions or anomalies may be performed by analyzing the tagged stream of events. Analysis of the tagged stream of events may be performed using a variety of detection techniques, including those described in FIG. 6.

FIG. 6 illustrates an embodiment of a process for detecting instances of network intrusion and anomaly. In an embodiment, one or more labeled streams 150 are transmitted to detectors 160. Detectors 160 are configured to facilitate execution of one or more approaches for intrusion detection and one or more approaches for detecting network anomalies. Detectors 160 may generate one or more aggregated alert streams 170, comprising alert messages, error notifications, administrative communications, and other types of communications indicating instances of network intrusion or anomaly.

In an embodiment, detectors 160 comprise a signature based intrusion detector 161, a classification based intrusion detector 163, a statistical anomaly detector 165, a regular expression based matcher 167, and a clustering based anomaly detector 171. Other approaches for intrusion detection may also be implemented.

Detectors 160 may comprise multiple sub-modules. Each sub-module may implement a different detection algorithm. Some of the detection algorithms may be configured to identify instances of misuse of the network resources. The sub-modules may analyze the sequence of events included in the stream of events and attempt to determine whether instances of access violation or breach of data security occurred. Other sub-modules may analyze individual event attributes and attempt to determine whether instances of for example, assumed identity occurred. Yet other sub-modules may be configured to identify instances of anomalous sequence of events or anomalous instances of the event sequences.

By deploying multiple detection algorithms to detect instances of network intrusion or anomaly, the system may attack the problem through different means and the means may be executed in parallel. Further, the approach allows collecting a wide scope of information useful in identifying true malicious events and eliminating false positives.

3.5.1 Intra-Event Misuse Detection

Intra-event misuse detection may be implemented in a variety of ways. For example, the intra-event misuse detection may be implemented using algorithms for signature based intrusion detection and event label classification. The algorithms may be executed in parallel on the same stream of data and in parallel on different streams of data.

In an embodiment, a signature based intrusion detector 161 implements algorithms for signature based intrusion detection. A signature based intrusion detector may analyze textual information of events in a tagged stream of events to determine the context of the events. For example, if an event is a syslog event comprising an error message encapsulated in a TCP data segment, then the content of the message (payload) may be extracted from the TCP data segment. The content of the message may be then parsed to identify a host IP address, a communications protocol, a destination port, and other information related to specific to the syslog message.

An example of a TruSQL query designed to execute signature based intrusion detection is provided below. The query combines contextual information and regular expression signatures to identify signatures of incidences of misuse of network resources.

Query 8: Example TruSQL Query for
Combining Contextual Information Using Regex Match

```
SELECT “WEB_ATTACK” as alert_type
FROM network_traffic_stream
WHERE dest_ip << inet ‘192.168.1/24’
AND protocol = ‘TCP’
    AND dest_port = 80
    AND payload ~ E’*conf\/httpd\.conf’
```

In Query 8, a WHERE clause is used to perform a context aware regular expression match process (Regex Match). A Regex Match approach allows searching for information strings in an input stream that match a provided pattern. The approach allows isolating the part of a stream that contains the provided pattern. In Query 8, the WHERE clause is used to determine whether an input “network traffic stream” contains a destination IP address of “192.168.1/24,” indicative of a host suspected of launching attacks on networks.

In an embodiment, addressing how to generate and customize queries for each possible type of alert may be supported by implementing rules and rule tables allowing identifying a variety of alert types.

In an embodiment, a signature based intrusion detector 161 implements a set of rules and rule tables to determine a variety of alerts. The rule tables may comprise rows, which define the streams to be processed, context filters to be applied to the streams, and regular expression to be applied to for example, payloads of data segments or packets. The rules may be extracted from the rule tables and used to match the signatures to the payloads. This approach is similar to the approach implemented in an event labeler, described above.

In an embodiment, a classification based intrusion detector 163 implements algorithms for classification based intrusion detection. A classification based intrusion detector 163 processes a labeled stream of events and labeled events to classify the streams and events into groups. This approach is similar to the approach implemented in a data splitter, described above. While a data splitter divides raw streams into parallel streams based on context, a classification based intrusion detector divides the events and streams based on the labels assigned to the streams and events.

In an embodiment, classification based intrusion detector 163 implements a Naïve Bayes (NB) classifier. The NB classifier is used to classify the labeled events as malicious or non-malicious. The NB classifier may be trained using historic, labeled data. Some of the advantages of the NB classifier include the simplicity, applicability to a vast number of implementations, and the high speed and efficiency in classifying the labeled events. The NB is also competitive when compared to other methods used in intrusion detection. Further, the NB classifier may be implemented as user-defined function executed in a database.

3.5.2 Anomaly Detection

Anomaly detection may be performed by analyzing attributes of individual events, and the analyzing of the attributes may be performed in a variety of ways. In an embodiment, the anomaly detection is performed by a statistical anomaly detector 165.

A statistical anomaly detector 165 may be configured to analyze attributes of individual events and based on the analysis, determine whether the data streams carry indications of instances of network anomalies. In an embodiment, statistical anomaly detector 165 is configured to detect anomalies that were previously unknown. Such attacks may be referred to as zero-day anomalies. The statistical anomaly detector 165 may be configured to do so without any training.

In an embodiment, a statistical anomaly detector 165 analyzes statistical information included in attributes of the events. The statistical attributes may include a count of connections established for a particular host, a count of bytes transmitted to and from a particular host, a count and names of the applications executed on a particular host, a count and names of the applications hosted on a particular host that generated a particular type of data traffic, and the like. Values of the statistical attributes may be compared with threshold values, such as baseline historic values and the like.

In an embodiment, values of statistical attributes of events may be compared with threshold values by calculating the Mahalanobis distance. In this approach, if a value of a particular statistical attribute of an event exceeds a threshold value by more than a predetermined Mahalanobis distance, then the event may be marked as an instance of anomaly. Events marked as instances of anomaly may be interpreted as instances of malicious behavior. This approach is usually implemented as a simple mechanism for detecting outliers.

3.5.3 Discrete Event Sequence Intrusion Detection

In contrast to the above-described detectors configured to analyze individual events, the detectors for performing the discrete event sequence intrusion detection are configured to analyze multiple events and multiple streams. Analyzing the multiple events and streams allows determining whether multiple events carry indications of instances of network intrusion even if the individual events do not seem to be malicious. This type of analysis may be performed by a regular expression based matcher 167.

As described earlier, a stream database provides a windowing mechanism for receiving streams of events, and an event labeler provides mechanisms for labeling the events with one or more event tags. A regular expression based matcher 167 may be configured to analyze the event tags in a sequence of events received in the time window.

Below is an example TruSQL query for analyzing event tags in a sequence of events received in a time window and for converting the tags into a string to which regular expressions, indicating malicious acts, may be applied.

Query 9: Example of TruSQL Query for
Converting Event Label Alphabet into Strings

```
SELECT t.host_id,
regexp_matches(t.event_str, E‘((?:B|D){3,} P)(?=.*?[\hat{ }H])’)
FROM
(SELECT source_ip as host_id,
array_to_string(array_agg(
CASE WHEN (counter_Kbytes > 20000)
          THEN ‘B’ ELSE ‘’ END ||
CASE WHEN (dest_ip << inet ‘192.168.1/24’)
    THEN ‘D’ ELSE ‘’ END ||
CASE WHEN (protocol = ‘TCP’)
          THEN ‘P’ ELSE ‘’ END ||
CASE WHEN (port = 80)
          THEN ‘H’ ELSE ‘O’ END), ‘’)
as event_str
FROM netflow_stream
GROUP BY source_ip) as t;
```

As shown in Query 9 above, a sequence of event labels may be represented as an alphabetized string. Using the Regex Match approach, described above, the string may be processed to determine whether any of known behavioral patterns may be identified in the string. For example, if an external machine tries to connect to multiple ports on a specific destination device within a very short period of time, then the labels assigned to the related events may be represented as an alphabetized string, and possible matches between the known behavioral patterns and elements of the string may be determined. If a match is found, then that may indicate an incident of misuse. The match may be found by applying a condition captured using a simple Regex Match pattern, and implemented in a TruSQL query.

In an embodiment, a regular expression based matcher 167 refers to a library of prior knowledge of behaviors and patterns. The library may be developed and modified as patterns are identified and developed. The patterns may be stored in a metadata tables, and used by regular expression based matcher 167 to find matches in the label string.

3.5.4 Clustering Based Anomaly Detection

In an embodiment, a clustering based anomaly detector 171 is configured to analyze tagged events, grouping the tags into clusters and determine whether the clusters of tags carry indications of an incidence of intrusion.

Clustering based anomaly detector 171 may utilize a variety of clustering techniques, including a k-medoid algorithm. The term “k-medoid” means a string having “k” elements or components. A k-medoid algorithm allows obtaining a set of medoid (event strings) specific to malicious and non-malicious traffic and events, and using the medoids to train the detector. The k-medoid clustering algorithm is usually run offline on historic data. In real-time, as an event stream is received and the events are tagged, the received tagged strings are compared with the previously calculated medoids. The comparison may be performed using a longest common subsequence (LCS) similarity measure. An event sequence is marked as anomalous if the length of the LCS exceeds a threshold length for the closest medoid.

The above described detectors are merely examples of detectors that may be implemented as part of detectors 160. The detectors 160 may be implemented as an expandable and modifiable module, configured to implement new and improved algorithms for detecting incidents of intrusion and anomaly. The detectors 160 are scalable and flexible to accommodate a variety of algorithms, a variety of training sessions, and a variety of external sources providing metadata, patterns, and sequences.

In an embodiment, detectors 160 aggregate alert streams into one or more aggregated streams of alerts. Aggregating the alert streams allows minimizing alert floods and helps managing false alerts. Aggregation of alerts may be performed by applying simple rules. For example, in case of anomaly detection, an alert may be forwarded to the network if the alert is corroborated by multiple alerts identified for the same host within the current time window and by multiple detectors. The number of detectors that need to corroborate may be customizable.

3.6 Rules

Referring again to FIG. 3, in step 340, a determination is made whether an instance of network intrusion or anomaly has been detected by detectors. If the incident has been detected, then in step 350, one or more actions are determined and communications comprising descriptions of the actions are transmitted to system managers, system administrators and others.

In step 360, it is determined whether any modifications to intrusion detectors and the detection process may be made, and if so, the modifications are performed. For example, it may be determined that new types of detectors may be implemented and incorporated in the detectors module. Also, it may be determined that threshold values used by the detectors need to be adjusted. Furthermore, it may be determined that the rules for detecting instances of network intrusion or anomaly need to be modified or new rules may be added.

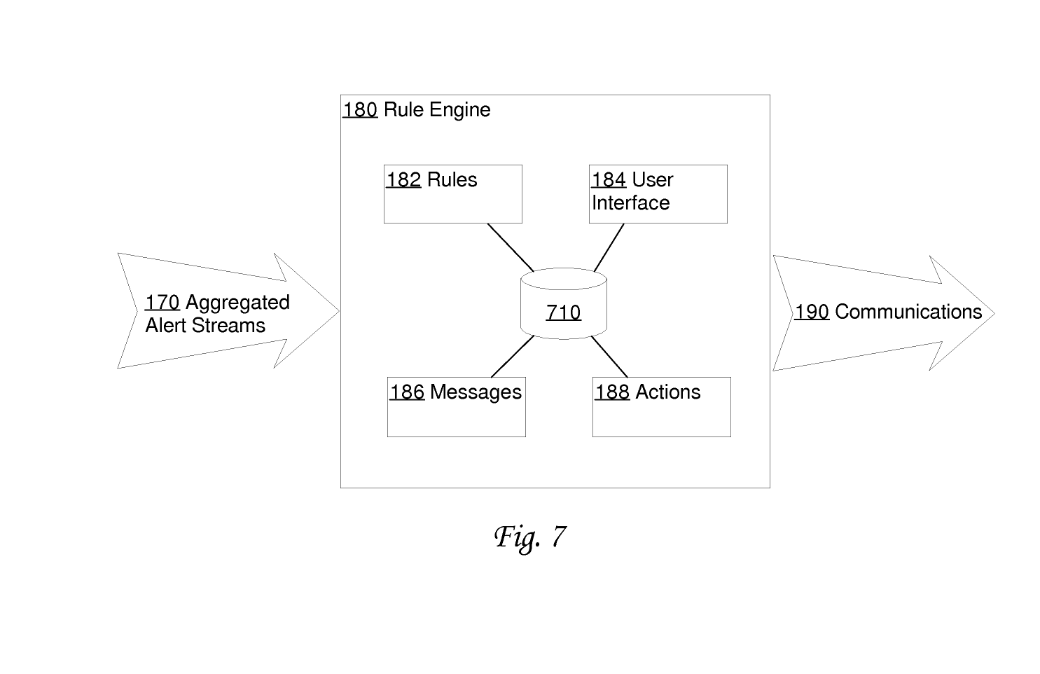

Referring again to step 340, determining whether an instance of network intrusion or anomaly has been detected may be performed by applying various rules to the outputs generated by the detectors. The rules may be applied by a rule engine, described in FIG. 7.

FIG. 7 illustrates an embodiment of a process for applying rules to alert streams. The alert streams may be generated by detectors, described above. The alert streams may be aggregated, as depicted in FIG. 7. Aggregating the alert streams may prevent flooding the system with alerts, and minimize distribution of false alerts. For example, the alerts that are not corroborated by other alerts may be eliminated as false positive. Also, the alerts indicating the same incident of network intrusion may be aggregated into one alert, and thus one alert, not multiple alerts pertaining to the same incident, are disseminated.

One or more single alert streams or an aggregated alert stream 170 may be transmitted to a rule engine 180 for processing, and output from the rule engine 180 comprising communications 190 may be transmitted to network managers, system administrator and users.

In an embodiment, a rule engine comprises a library of rules 182, a library of messages 186, a library of actions 188 and a user interface 184. A library of rules 182 may contain human defined if-then rules that may be applied to the alerts generated by detectors. A library of messages 186 may comprise templates of various messages containing information about alerts, actions and the like. A library of actions 188 may contain descriptions of various actions that may be communicated in messages and communications 190. The actions may be determined using, for example, a standard Rete algorithm, and the action may be communicated as part of communications 190 to network administrators, manager, users and other systems.

User interface 184 may be configured to enter and modify information stored in rules library 182, messages library 186 and actions library 188. The rule engine 180 may provide the user interface 184 for a human expert to define rules to be applied to alerts, and to define messages and actions to be sent as part of communications 190.

Although FIG. 1-2 depict a rule engine 180 configured separately from an event stream database, such a configuration is optional. The rule engine 180 may be either separate from an event stream database or part of the event stream database.

In an embodiment, the rule engine 180 is a reasoning engine that includes a forward chaining inference approach for reasoning, and usually implements an object-oriented interface for entering user-defined rules. An example of a user-defined rule containing an if-then construct is provided below:

Rule 1: Sample Domain Expert Defined If-Then Rule

```
RULE “Ignore Backup”
  WHEN
      a:Anomaly (type == “HIGH_TRAFFIC”,
            host==”10.1.1.70”)
    Time (hour < 23)
  THEN
    Server.email(“Unusual traffic on host ” +
                  a.getHost( ))
END
```

The above Rule 1 is defined to ignore instances and alerts of heavy traffic experiences between 11 PM and midnight because during that time, the heavy traffic is expected since many computer systems generate backups during that time. In particular, according to Rule 1, if an anomaly alert “HIGH_TRAFFIC” has been received from a particular host, then the value of the time attribute is checked. If the time attribute indicates that the alert was received prior to 11 PM, then a message indicating an occurrence of unusually heavy traffic on the particular host is generated and sent. However, if the time attribute indicates that the alert was received at 11 PM or after, then the alert is ignored as the heavy traffic is expected during that time.

Rule engine 180 plays an important role in detecting instances of network intrusion and anomaly. It adds an essential layer of filters that may be designed by experts and customized to fine-tune alerts generated by the network intrusion detectors. The rule engine 180 also allows customizing the context in which the alerts may be interpreted and processed.

Deploying a rule engine in conjunction with an event stream database provides a powerful tool for detecting incidents of network intrusion and anomaly in a variety of systems and configurations. A combination of an event stream database, which seems to be an ideal platform for handling voluminous, fast traveling traffic, with the above described rule engine and detectors provides a very useful tool for the efficient processing of stream events and accurate detection of instances of most complex and sophisticated attacks on a network.

4.0 Implementation Mechanisms—Hardware Overview

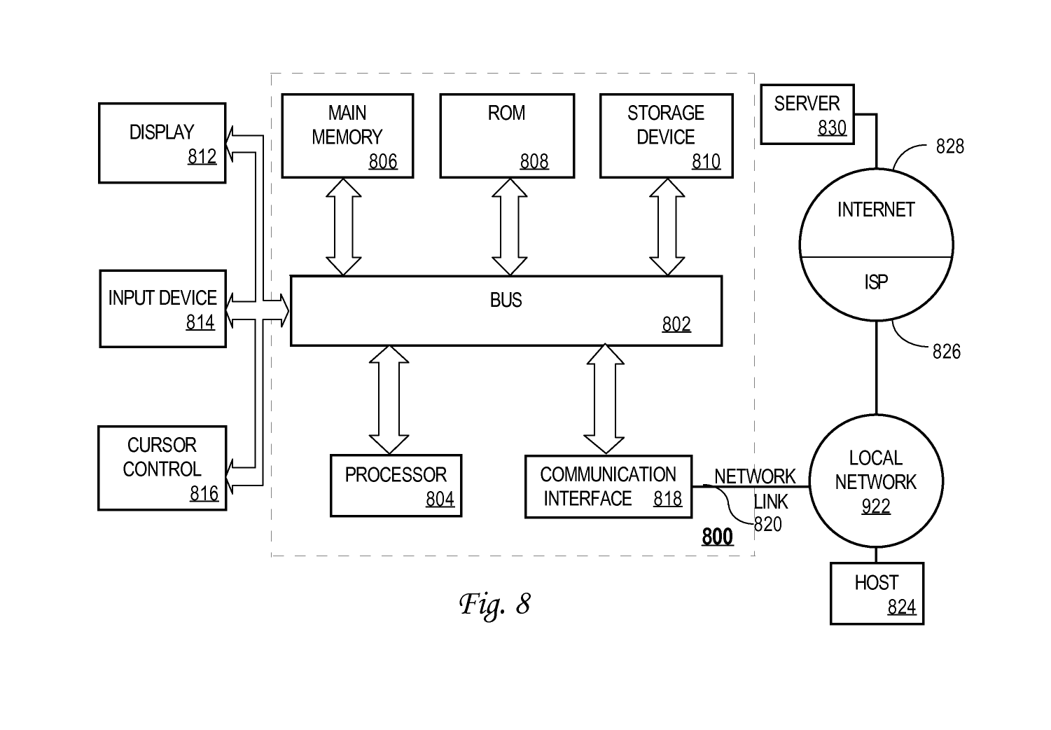

FIG. 8 is a block diagram that illustrates a computer system 800 upon which an embodiment of the disclosure may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The disclosure is related to the use of computer system 800 for implementing the techniques described herein. According to one embodiment of the disclosure, those techniques are performed by computer system 800 in response to processor 804 executing one or more sequences of one or more instructions contained in main memory 806. Such instructions may be read into main memory 806 from another machine-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the disclosure. Thus, embodiments of the disclosure are not limited to any specific combination of hardware circuitry and software.

The term “machine-readable medium” as used herein refers to any medium that participates in providing data that causes a machine to operation in a specific fashion. In an embodiment implemented using computer system 800, various machine-readable media are involved, for example, in providing instructions to processor 804 for execution. Such a medium may take many forms, including but not limited to storage media and transmission media. Storage media includes both non-volatile media and volatile media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

5.0 Extensions and Alternatives

In the foregoing specification, embodiments of the disclosure have been described with reference to numerous specific details that may vary from implementation to implementation. The specification and drawings are, accordingly, to be regarded in an illustrative rather than a restrictive sense.

What is claimed is:

1. A computer-implemented data processing method comprising:
using computing apparatus, receiving one or more data streams, determining one or more characteristics of the one or more data streams, and based on the one or more characteristics of the one or more data streams, determining one or more tags for the one or more data streams;
using computing apparatus, determining whether the one or more tags indicate one or more malicious patterns representative of network intrusions;
using computing apparatus, in response to determining that the one or more tags indicate one or more malicious patterns representative of network intrusions:
generating, based on the one or more tags, one or more aggregated alert streams;
applying one or more rules to the one or more aggregated alert streams and receiving a result indicating whether a network intrusion is in progress;
in response to receiving the result indicating that the network intrusion is in progress, determining and executing one or more remedial actions.

2. The method of claim 1, wherein the determining one or more tags for the one or more data streams comprises, using computing apparatus, performing one or more of:
determining whether a particular attribute value associated with a particular characteristic of the one or more characteristics exceeds an attribute threshold value, and in response thereto, adding a first tag to a set of the one or more tags;
determining whether a particular statistical anomaly value associated with the particular characteristic of the one or more characteristics exceeds a statistical threshold value, and in response thereto, adding a second tag to the set of the one or more tags;
determining whether one or more attribute values associated with the one or more characteristics of the one or more data streams form a known pattern, and in response thereto, adding a third tag to the set of the one or more tags.

3. The method of claim 1, wherein the determining whether the one or more tags indicate one or more malicious patterns comprises:
executing both misuse and anomaly detection algorithms in parallel on the one or more data streams to generate one or more alerts indicating one or more possible patterns;
analyzing the one or more alerts to identify a subset of alerts by excluding false alerts from the one or more alerts;
aggregating the subset of alerts into the one or more aggregated alert streams;
based on the one or more aggregated alert streams, determining the one or more tags indicating the one or more malicious patterns representative of network intrusions.

4. The method of claim 1, wherein the determining whether the one or more tags indicate one or more malicious patterns representative of network intrusions comprises performing one or more of an intra-event intrusion detection and performing a discrete event sequence intrusion detection.

5. The method of claim 4, wherein the performing the intra-event intrusion detection comprises performing one or more of a signature based intrusion detection, a classification based intrusion detection, a statistical anomaly detection.

6. The method of claim 4, wherein the performing the discrete event sequence intrusion detection comprises performing one or more of a regular expression based matching, a clustering based anomaly detection.

7. The method of claim 1, wherein the one or more characteristics of the one or more data streams comprise one or more of physical attributes, communication attributes, network and flow characteristics, packet content.

8. The method of claim 1, wherein the one or more data streams are received using a streaming database.

9. A computer system comprising:
one or more processors;
a stream database unit coupled to the one or more processors and configured to use computing apparatus to:
receive one or more data streams;
determine one or more characteristics of the one or more data streams;
based on the one or more characteristics of the one or more data streams, determine one or more tags for the one or more data streams;
determine whether the one or more tags indicate one or more malicious patterns representative of network intrusions;
in response to determining that the one or more tags indicate one or more malicious patterns representative of network intrusions, generate, based on the one or more tags, one or more aggregated alert streams;
a rule engine configured to:
apply one or more rules to the one or more aggregated alert streams and receive a result indicating whether a network intrusion is in progress;
in response to receiving the result indicating that the network intrusion is in progress, determine and execute one or more remedial action.

10. The intrusion detection system of claim 9, wherein the stream database unit is further configured to use computing apparatus to:
determine whether a particular attribute value associated with a particular characteristic of the one or more characteristics exceeds an attribute threshold value, and in response thereto, adding a first tag to a set of the one or more tags;
determine whether a particular statistical anomaly value associated with the particular characteristic of the one or more characteristics exceeds a statistical threshold value, and in response thereto, adding a second tag to the set of the one or more tags;
determine whether one or more attribute values associated with the one or more characteristics of the one or more data streams form a known pattern, and in response thereto, adding a third tag to the set of the one or more tags.

11. The intrusion detection system of claim 9, wherein the stream database unit is further configured to use computing apparatus to:
execute both misuse and anomaly detection algorithms in parallel on the one or more data streams to generate one or more alerts indicating one or more possible patterns;
analyze the one or more alerts to identify a subset of alerts by excluding false alerts from the one or more alerts;
aggregate the subset of alerts into the one or more aggregated alert streams;
based on the one or more aggregated alert streams, determine the one or more tags indicating the one or more malicious patterns representative of network intrusions.

12. The intrusion detection system of claim 9, wherein the stream database unit comprises:
a data splitter coupled to an event labeler that is configured to produce a labeled derived stream;
a sequence pattern detection unit, an event pattern detection unit, an event anomaly detection unit, and a sequence anomaly detection unit, each unit configured to receive the labeled derived stream and to produce the one or more aggregated alert streams.

13. A non-transitory computer-readable storage medium storing one or more instructions which, when executed by one or more processors, cause performing:
using the one or more processors, receiving one or more data streams, determining one or more characteristics of the one or more data streams, and based on the one or more characteristics of the one or more data streams, determining one or more tags for the one or more data streams;
using the one or more processors, determining whether the one or more tags indicate one or more malicious patterns representative of network intrusions;
using the one or more processors, in response to determining that the one or more tags indicate one or more malicious patterns representative of network intrusions:
generating, based on the one or more tags, one or more aggregated alert streams;
applying one or more rules to the one or more aggregated alert streams to determine whether a network intrusion is in progress;
in response to determining that the network intrusion is in progress, determining and executing one or more remedial action.

14. The non-transitory computer-readable storage medium of claim 13, comprising instructions which, when executed, cause:
determining whether a particular attribute value associated with a particular characteristic of the one or more characteristics exceeds an attribute threshold value, and in response thereto, adding a first tag to a set of the one or more tags;
determining whether a particular statistical anomaly value associated with the particular characteristic of the one or more characteristics exceeds a statistical threshold value, and in response thereto, adding a second tag to the set of the one or more tags;
determining whether one or more attribute values associated with the one or more characteristics of the one or more data streams form a known pattern, and in response thereto, adding a third tag to the set of the one or more tags.

15. The non-transitory computer-readable storage medium of claim 13, comprising instructions which, when executed, cause:
executing both misuse and anomaly detection algorithms in parallel on the one or more data streams to generate one or more alerts indicating one or more possible patterns;
analyzing the one or more alerts to identify a subset of alerts by excluding false alerts from the one or more alerts;
aggregating the subset of alerts into the one or more aggregated alert streams;
based on the one or more aggregated alert streams, determining the one or more tags indicating the one or more malicious patterns representative of network intrusions.

16. The non-transitory computer-readable storage medium of claim 13, comprising instructions which, when executed, cause: performing an intra-event intrusion detection, performing a discrete event sequence intrusion detection.

17. The non-transitory computer-readable storage medium of claim 13, comprising instructions which, when executed, cause: performing a signature-based intrusion detection, performing a classification-based intrusion detection, performing a statistical anomaly detection.

18. The non-transitory computer-readable storage medium of claim 13, comprising instructions which, when executed, cause: a regular expression based matching, a clustering based anomaly detection.

19. The non-transitory computer-readable storage medium of claim 13, wherein the one or more characteristics of the one or more data streams comprise one or more of: physical attributes, communication attributes, network and flow characteristics, packet content.

20. The non-transitory computer-readable storage medium of claim 13, wherein the one or more data streams are received using a streaming database.
